(19) United States
(12) Patent Application Publication
(10) Pub. No.: US 2005/0200489 A1
(43) Pub. Date: Sep. 15, 2005

(54) Cushion immersion sensor

(76) Inventors: David J. Sloop, Chesterfield, MO (US); David Parsons, Swansea, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/064,534

(22) Filed: Feb. 24, 2005

Related U.S. Application Data
(60) Provisional application No. 60/547,117, filed on Feb. 24, 2004.

(51) Int. Cl. G08B 23/00

(52) U.S. Cl. 340/573.7; 340/686.1; 340/667; 5/654

(57) ABSTRACT

A sensor for an inflatable cushion, the sensor including a base with a conductive area in an appropriate configuration relative to the area of the patient's anatomy positioned on the cushion. The conductive area of the base can be optimally configured to correspond to the bony prominences of the buttocks or ischia position on an air cell cushion. There are electrodes connected to the conductive area that generate an electromagnetic field of a predetermined configuration. A disturbance of the electromagnetic field created by a change in position of the patient is transmitted to an indicator so that an observer can determine if the patient is appropriately immersed in the cushion.

### CROSS-REFERENCE TO RELATED APPLICATIONS

This application claims the benefit of provisional patent application Ser. No. 60/547,117, filed Feb. 24, 2004, which is incorporated herein by reference.

### BACKGROUND OF THE INVENTION

In the prior art, specialized cushions and mattresses for preventing decubitus ulcers are known. The cushions or mattresses, particularly air cell cushions or mattresses, are implemented in a variety of applications, such a wheelchairs, seats and beds. The cushions have various designs but generally are inflated with air to lift the person resting upon the cushion. One representative embodiment of an air cell cushion is disclosed in U.S. Pat. No. 4,541,136, which is incorporated herein by reference.

In many instances, the cushion is divided into zones, which may be separately inflated to different pressures in order to provide comfort and/or support to different areas of the body. A representative embodiment of such a zoned cushion and valve is disclosed in U.S. Pat. No. 6,564,410, which is incorporated herein by reference. To avoid decubitus ulcers, the cushion is set to a pressure that provides optimal immersion of the person within the cushion.

Optimal immersion occurs when the cushion is not so under-inflated that the person “bottoms out”, i.e. their body is supported directly by the chair or bed, rather than being directly supported by the cushion of air, but not so over-inflated that the surface area of the cushion area supporting the body is small and hard, such that the pressure per unit area exerted upon the body is high. Optimal immersion allows the spreading of pressure over a greater area of the anatomy to prevent pressure sores. One method of positioning and seating of the patient is provided in U.S. Pat. No. 6,564,410. In the past, there was no precise way to know whether the person being supported was at the proper immersion level.

Additionally, changing g-forces applied to the person or environment changed the proper pressure within the cushion to achieve proper immersion. Moreover, for elderly people or people suffering from loss of feeling in areas of the body supported by the cushion, the person could not give feedback to an assistant as to whether they were properly immersed in the cushion. The present invention solves this problem by providing a simple, cost-effective and precise method and apparatus for providing feedback as to the current immersion of the person within the cushion such that the appropriate pressure may be maintained within the cushion to provide the appropriate immersion depth.

### SUMMARY OF THE INVENTION

One aspect of the invention is an immersion sensor that is positioned under a cushion or mattress so as to indicate when a patient resting on the cushion or mattress is properly immersed in the cushion or mattress to optimally relieve pressure on the patient's body.

In one aspect of the invention, the sensor comprises a base having a conductive area in an appropriate configuration relative to the area of the patient's anatomy that will be contacting the cushion. For example, the conductive area of the base can be optimally configured to correspond to the bony prominences of the buttocks or ischia position on an air cell cushion. There are electrodes connected to the conductive area and generate an electromagnetic field of a predetermined configuration. As the patient is positioned on the cushion, there is a disturbance of the electromagnetic field. That data is transmitted to a indicator so that an observer can determine if the patient is appropriately immersed in the cushion.

### BRIEF DESCRIPTION OF THE DRAWINGS

FIG. 1 is a perspective view of the immersion sensor of the present invention;

FIG. 2 is a perspective view of the immersion sensor positioned under a air cell cushion;

FIG. 3 is a series of drawings and an equation developed by the inventor to illustrate operation of the immersion sensor; and

FIG. 4 is a perspective view of the visual indicator.

### DESCRIPTION OF THE PREFERRED EMBODIMENT

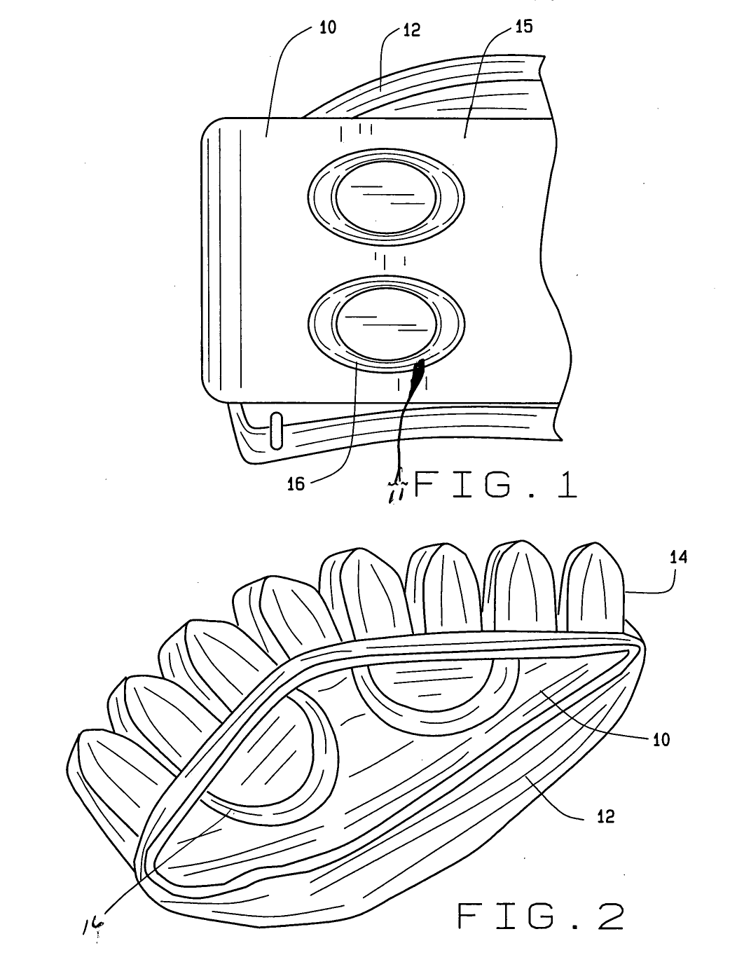

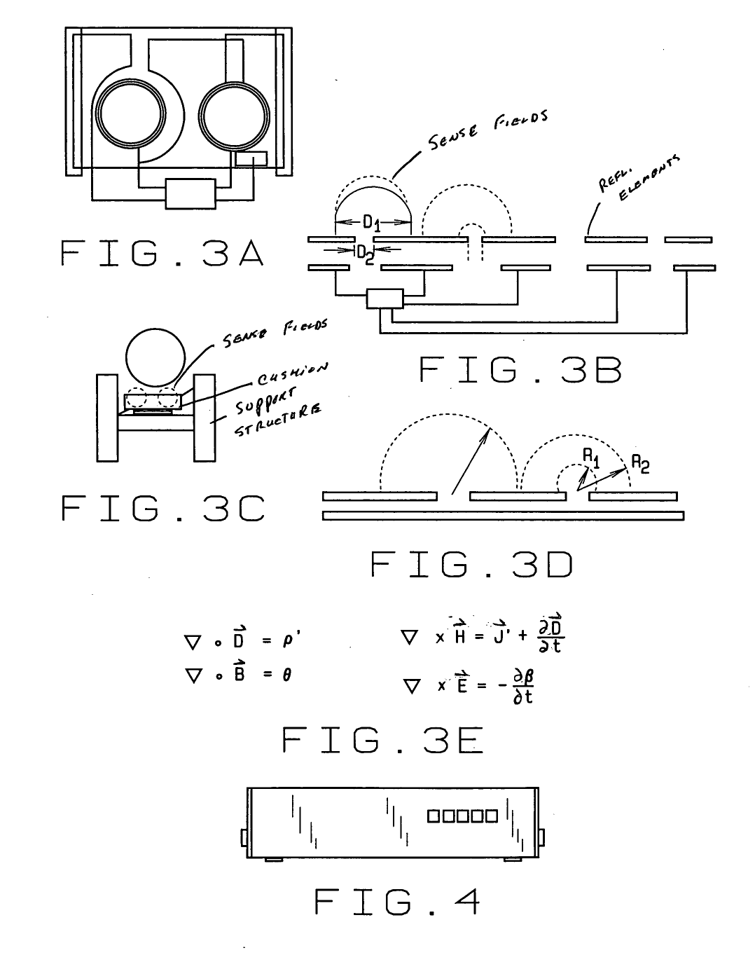

Referring to FIG. 1, there is shown an immersion depth feedback device 10 according to the present invention. The device 10, in the example shown, is placed upon the seat of a wheelchair 12. Referring to FIG. 2, an inflatable air cell cushion 14 is placed over the device 10 and upon which a person will sit. Referring to FIG. 3, the device includes a base comprising a conductive material 15 and nonconductive areas 16. Electrodes (not seen) are attached to the conductive area in a predetermined pattern. The conductive area generates an electromagnetic field, which changes with the proximity of the person's body to the sensor, i.e. as it gets closer or farther from the conductive area. Based upon the change in the electromagnetic field, the optimal distance from the conductive area, i.e. the immersion into the cushion may be determined and/or altered.

FIG. 3 illustrates various aspects of the invention. For example, drawing A is a schematic of an embodiment of an immersion sensor of the present invention. Drawing B is a schematic, side elevation that illustrates one embodiment of pattern of an electromagnetic field for use with a wheelchair cushion, for example. Drawing B also illustrates reflective elements below the conductive area to properly reflect the electromagnetic field. Drawing C is another schematic showing a sensor on a support structure, e.g. chair with a cushion on the sensor and a subject seated on the cushion. It should be noted that the sensor is not sensitive to the support structure. Drawing D shows the electromagnetic field. Equations used to determine the appropriate configuration for the electromagnetic field are shown at E in FIG. 3.

Referring to FIG. 4, circuitry to detect the changing electromagnetic field is employed to indicate to the person or an assistant the current immersion depth of the person within the cushion. The indication is provided by a series of light emitting diodes, the center of which indicates an appropriate immersion and the diodes to the left and right of center indicating an under- or over-inflated condition. From this indication, the pressure in the cushion can be increased or decreased. The indicator can also provide audible signals or a combination of audible and visual indicators.

It will be appreciated that the pattern of the conductive area, electrodes and resulting electromagnetic field can be adapted to conform to use. For example, a different pattern would be used for a mattress or a cushion placed under the heels of the patient. The pattern shown in the drawing is illustrative for a seat cushion, but should not be considered limiting.

It will be appreciated that the circuitry could be included in a closed loop system so that feedback to a pump could be used to change the inflation of the cushion based upon changes in the electromagnetic field.

It also will be appreciated that the change in electromagnetic field can be used to detect physiological changes, such as body temperature, weight, and so forth, with the detected changes being converted to electronic signals sent to appropriate visual or auditory indicators.

1. A sensor for positioning under a cushion or mattress, comprising:
a base having a conductive area in an appropriate configuration relative to an area of a user's anatomy that will be contacting the cushion or mattress;
electrodes connected to the conductive area capable of generating an electromagnetic field of a predetermined configuration; and
an indicator apparatus;
wherein a disturbance of the electromagnetic field is transmitted to the indicator apparatus so as to indicate if the user is appropriately immersed in the cushion.

2. The sensor of claim 1 wherein the conductive area of the base is configured to correspond to the bony prominences of the buttocks of the user.

3. A sensor for positioning under a cushion or mattress comprising means for generating a predetermined electromagnetic field and means for determining changes or alterations in the field caused by the positioning of a subject on the cushion or mattress.
